(19) United States
(12) Patent Application Publication
(10) Pub. No.: US 2010/0187943 A1
(43) Pub. Date: Jul. 29, 2010

(54) ELECTRICAL MACHINE WITH ELECTRICALLY INSULATED WINDING ELEMENTS

(75) Inventor: Bruno Heim, Grosseibstadt (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, MUNCHEN (DE)

(21) Appl. No.: 12/669,310

(22) PCT Filed: Jul. 11, 2008
(86) PCT No.: PCT/EP08/59082

§ 371 Date: Jan. 15, 2010

(30) Foreign Application Priority Data
Jul. 19, 2007 (DE) 10 2007 033 754.1

(51) Int. Cl. H02K 3/34

(52) U.S. Cl. 310/215

(57) ABSTRACT

The invention relates to an electrical machine (1) comprising a base body (2) having two axial front sides (4) and grooves (7) for receiving electrical conductors of a winding system (9). An end disk (5) comprising axially protruding deflecting journals (6) is respectively arranged on each front side (4). The electrical conductors of the winding system (9) are wound around the deflecting journals (6) such that a winding head is respectively formed on each front side (4). The winding system (9) comprises a plurality of partial windings (12) which are axially adjacently arranged, at least in sections, in the vicinity of the winding heads.; An electrically insulating separating layer (14) consisting of a matt-type material which is flexible at least in a basic state is provided in an overlapping region (13) between two partial windings (12) axially adjacently arranged in the vicinity of the winding heads.

The invention relates to an electrical machine having a base body which contains two axial end faces as well as slots for holding electrical conductors of a winding system, wherein one end disk with axially projecting deflection pins is in each case arranged on each of the end faces, the electrical conductors of the winding system are passed around the deflection pins such that an end winding is in each case formed on each of the end faces, and the winding system has a plurality of winding elements which are arranged at least in places axially adjacent to one another in the area of the end windings.

An electrical machine such as this is described, for example, in DE 10 2005 037 373 A1. In particular, this is in the form of an electric motor whose base body is, for example, in the form of a stator or laminated stator core. The winding system may have a plurality of winding elements which are introduced into the laminated stator core successively. In particular, the winding elements may be the phase windings which are associated with each of the electrical phase strands, and which are assembled to form the winding system. The electrical conductors are deflected on the axial end faces of the base body and are passed from one slot to another slot. This therefore results overall in the end windings on both axial end faces, and these end windings also govern the external dimensions and, in particular, the overall axial length, of the electric motor.

In the electrical machine according to DE 10 2005 037 373 A1, the electrical conductors are deflected in the end winding area by means of separate guide shells with a U-shaped or L-shaped cross-sectional profile. The guide shells are used to guide and hold winding elements. They also ensure that the winding elements which are in each case held in the end winding area are electrically isolated from one another. These guide shells are each specifically matched to a specific motor geometry and to the winding layout that is used. They cannot be used for other geometries and/or for other winding variants. It is therefore necessary either to provide a very wide range of variants for the guide shells, or they must in each case be modified for a conversion or redesign of the electrical machine. The first option requires a considerable amount of logistic effort, and the second involves the need for more time. Both options are therefore costly. In addition, the guide shells occupy a certain amount of space, which is also included in the overall dimensions of the electrical machine.

The object of the invention is therefore to specify an electrical machine of the type mentioned initially in which electrical isolation between adjacent winding elements in the end winding area can be achieved easily and variably.

This object is achieved by the features of independent patent claim 1. The electrical machine according to the invention is a machine in which an electrically insulating isolating layer composed of a matt-like material which is flexible at least in a basic state is provided in an overlap zone between two winding elements which are arranged axially adjacent to one another in the area of the end windings.

The electrical machine according to the invention is distinguished by the particularly space-saving electrically insulating isolating layers whose options for use are highly variable and which are provided according to the invention between axially adjacent, in particular between axially mutually adjacent, winding elements. The isolating layers are preferably thin and flat and, at least in their basic state, that is to say in the state in which in particular they have not yet been used, do not have a significant structure in the axial direction, that is to say in the direction of the rotation axis of the electrical machine. They are composed of a matt-like or web-like material which is mechanically flexible, in particular in the basic state in which they have not yet been installed in the electrical machine. That is to say, in this state, it is preferably still flexible and can accordingly be stored very easily and in a space-saving manner on rolls. Furthermore, the isolating layer which is actually required can be produced in the respective required shape and size without any problems from the matt-like basic material, for example by appropriate cutting out or stamping out. In consequence, there is no need for costly storage of different variants of the isolating layer. Furthermore, because they are very thin, for example with a thickness of less than 0.5 mm, the isolating layers have virtually no influence on the external dimensions of the electrical machine.

Advantageous refinements of the electrical machine according to the invention are specified by the features in the claims which are dependent on claim 1.

In one advantageous variant, the isolating layer comprises a fiber fabric. These can be produced very well and at low cost. At the same time, they offer a range of advantageous characteristics, such as high mechanical robustness and resistance to tearing.

Furthermore, the matt-like material of the isolating layer can preferably be impregnated with a resin. When the material is in the basic state, and in particular also while the isolating layer is being fitted, the resin is in a preferably only pre-polymerized state. The isolating layer is then still flexible and can be matched to the characteristics, in particular to the surface contour, of the winding element onto which it is placed or positioned. In this state, the material of the isolating layer is, in particular, sticky, which means that it can be prefixed well in the final position. The resin of the matt-like material of the isolating layer is preferably cured in the finally fitted state of the end windings. In this case, the resin is advantageously cured only after the isolating layer has been fitted, when it is in its final position. After curing, the isolating layer contributes considerably to the robustness of the end winding. It also ensures that the covered winding element remains in the desired shape.

According to another preferred variant, the matt-like material of the isolating layer can be cured by heat. Heat treatment can be carried out easily. It is used in any case in various manufacturing stages of an electrical machine and therefore does not result in any significant additional effort. Furthermore, there are a large number of available substances, such as polymers, which have the characteristic that can be cured by heat.

Furthermore, the conductors of the winding system can also preferably be provided with a surface coating which can be cured by heat and in particular is sticky. Electrical conductors such as these, which are also referred to as stove-enamel wires, then have the same advantages as those which have already been described above in conjunction with the material of the isolating layers. Furthermore, heat treatment after the winding process allows the electrical conductors to be fixed in the position in which they have been placed during winding. A certain amount of prefixing is also provided by the adhesive force effect even before the heat treatment. After the heat treatment, in particular, this results in a solid assembly, which in particular is dimensionally stable, composed of individual coated electrical conductors that are held together. In particular, a joint heat treatment process can be carried out for curing the surface coating on the electrical conductors of a winding element and for curing the resin in the isolating layer that has been placed on this winding element.

In the finally fitted state, at least some of the conductors of a winding element are preferably connected to one another, in particular by being adhesively bonded to one another, in the area of the end windings. The winding elements and the end winding are therefore provided with their overall shape.

In a further advantageous refinement, the isolating layer merges at least in places with the surface contour of one of the two winding elements which are arranged axially adjacent to one another and between which the isolating layer is arranged. This once again provides dimensional stability, and is highly space-saving. The isolating layer is then no longer completely planar. At least in places, it adopts the uneven features that are present on the surface of the covered winding element.

In another advantageous variant, the isolating layer is a stamped-out element. The isolating layer can therefore be produced very easily and quickly, with widely differing shapes and dimensions, depending on the specific application.

According to another advantageous refinement, the isolating layer has openings through which the deflection pins are passed. The isolating layer can therefore be fitted at its intended final position, and fixed there, very well. There is no need for any complex (re)adjustment during or after the insertion of the isolating layer. Incorrect fitting with inadequate electrical isolation between the adjacent winding elements resulting from incorrectly inserted isolating layers could in this way very largely be precluded.

Further features, advantages and details of the invention will become evident from the following description of one exemplary embodiment, with reference to the drawing, in which:

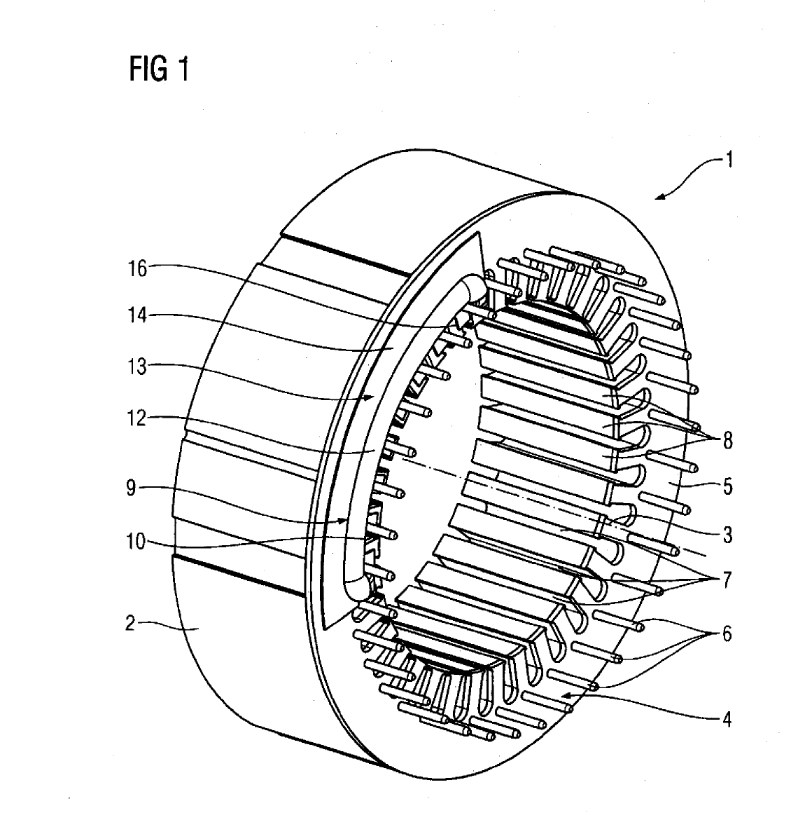

FIG. 1 shows one exemplary embodiment of a partially wound electrical machine, in the form of a perspective partial illustration,

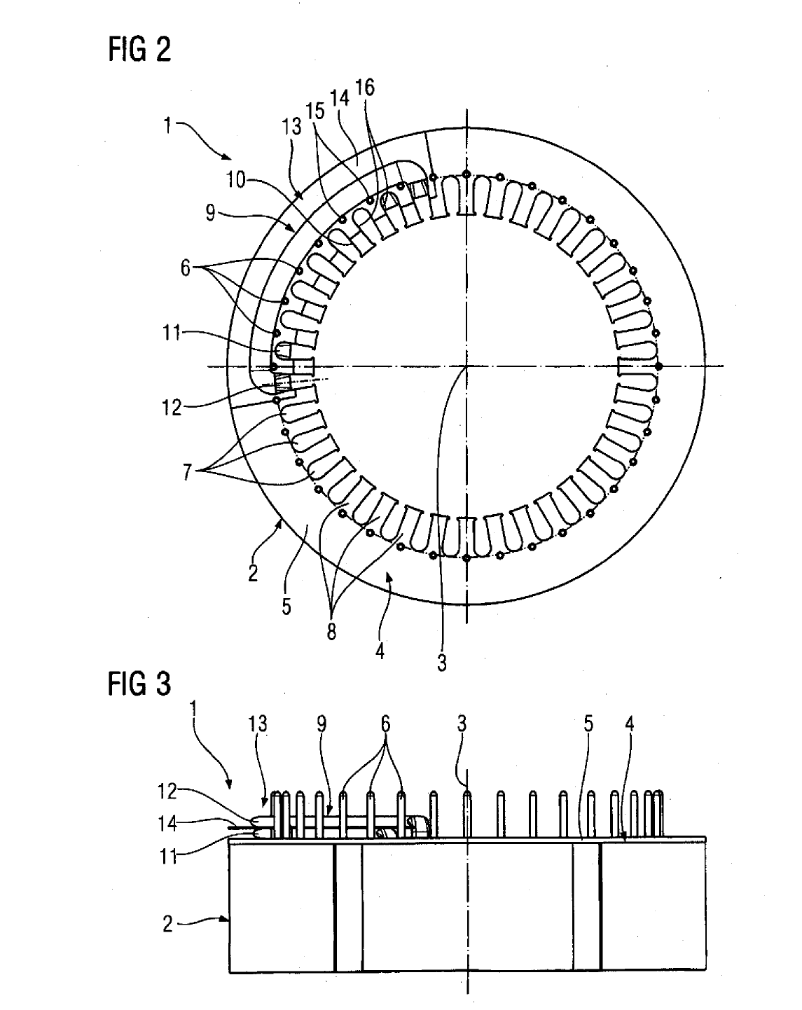

FIG. 2 shows the electrical machine as shown in FIG. 1, in a plan view of an axial end face, and

FIG. 3 shows a side view of the electrical machine as shown in FIGS. 1 and 2.

Mutually corresponding parts are provided with the same reference symbols in FIGS. 1 to 3.

FIGS. 1 to 3 show various views of one exemplary embodiment of a partially wound electrical machine 1. The electrical machine 1, which is in the form of an electric motor, has a base body 2 that is to be wound and a rotor, which is not illustrated in FIGS. 1 to 3 but is mounted such that it can rotate about a rotation axis 3. The base body 2 is part of a stator of the electrical machine 1, and is in the form of a laminated stator core. It has two axial end faces, only one end face 4 of which is shown in FIGS. 1 to 3. An electrically insulating end disk 5 is arranged on each of the two end faces. The end disk 5 has axially projecting, molded-on deflection pins 6 which are arranged uniformly distributed in the circumferential direction and, in the illustrated exemplary embodiment, have a uniform and in particular round cross section.

The base body 2 has a stator bore in which the rotor, which is not illustrated in FIGS. 1 to 3, is placed in the finally fitted state. Axially running slots 7, which are distributed uniformly over the circumference, are provided in the base body 2, adjacent to an inner wall of this stator bore. If required, the slot profile may have a slight inclination, rather than being exactly in the axial direction as shown in FIGS. 1 and 2, that is to say a direction running parallel to the rotation axis 3. Slot webs 8 are arranged between the slots 7.

The isolating end disk 5 is arranged on the end face 4 such that its deflection pins 6 are aligned with the slot webs 8. The number of deflection pins 6 and slot webs 8 is the same.

Electrical conductors of an electrical winding system 9 which is to be introduced into the base body 2 are placed within the slots 7. In the exemplary embodiment, the base body 2 is shown in a partially wound state. Electrical conductors of the winding system 9 have been arranged in only some of the slots 7. On the end face 4, the slots 7 have slot end openings 10, from which the electrical conductors project, in order to be deflected on the end face 4 outside the base body 2, and passed to another of the slots 7. This deflection and routing of the electrical conductors are carried out by means of the deflection pins 6 on the isolating end disk 5. One end winding of the winding system 9 is therefore likewise formed in each case on the end face 4, in the same way as that on the second end face, which is not shown in FIGS. 1 to 3.

The end disk 5 can be used universally and allows winding systems 9 to be produced for different numbers of poles. In particular, two-pole, four-pole, six-pole or eight-pole windings are therefore possible.

The winding system 9 comprises a plurality of winding elements, of which two winding elements 11 and 12 are shown in the FIG. These are arranged axially adjacent to one another in places, in the area of the illustrated axial end winding. In this case, they are adjacent to one another within an overlap zone 13. Within the overlap zone 13, an electrically insulating isolating layer 14 is arranged between the two axially adjacent and mutually adjacent winding elements 11 and 12.

The isolating layer 14 is composed of a resin-impregnated fiber fabric, which is in the form of a flat and thin matt or substance web. Before insertion into the winding system 9, the isolating layer 14 is flexible, since the resin has not yet been completely polymerized. The resin is only pre-polymerized, as a result of which the isolating layer 14 is also somewhat sticky in this basic state. The material of the isolating layer 14 can be cured by heat, that is to say it can be changed to a hard final state by means of heat treatment. In particular, this is done on the basis of the complete polymerization of the impregnation resin.

The isolating layer 14 is a stamped part which is stamped out from a larger web of the resin-impregnated fiber fabric in the desired shape and size, by means of a simple stamping step. The shapes and sizes that are provided are thus highly variable.

In the illustrated exemplary embodiment, the isolating layer 14 has a basic shape in the form of an annular segment, in which aperture openings 15 and, on the inner segment curve, edge cutouts 16, are provided. The aperture openings 15 have an opening geometry which corresponds approximately to the cross-sectional geometry of the deflection pins 6. In the fitted state, the deflection pins 6 are passed through the aperture openings 15. The edge cutouts 16 in contrast have a shape which is matched to that of the slot end openings 10, in order to allow the electrical conductors of the winding system to be passed over an inserted isolating layer 14 at these points, without them being adversely affected.

In order to manufacture one of the winding elements 11 and 12 for the winding system 9, the laminated stator core of the base body 2 is wound using a needle winder, with a winding nozzle of the needle winder inserting the electrical conductor into one of the slots 7, and being moved progressively in the axial direction within the stator bore. The winding nozzle (=needle) is first of all moved slightly outward in the axial direction on the end face 4. The electrical conductor is then passed around a corresponding number of deflection pins 6 in the form of a circular arc, by the laminated stator core being rotated, for example, to such an extent about the rotation axis 3 that the slot end opening 10 of that slot 7 in which the electrical conductor is passed back in the opposite direction within the stator bore appears at the same level as the winding nozzle. The process is carried out in mirror-image form on the opposite end face. This is repeated in a corresponding manner for the number of turns desired for this winding element 11 or 12. If required, a segment disk matched to the stator geometry can also be used as an auxiliary tool in this case, in order to guide the electrical conductors in the area of the deflection pins 6 of the end disk 5 and to ensure that the winding element 11 or 12 has a flat axial dimension in this area. In particular, this allows a flat coil chamber or winding element chamber to be formed in this way.

After completion of the lower winding element 11, the isolating layer 14 is fitted in its basic state, in which it is flexible and slightly sticky, by its aperture holes 15 being pushed onto the deflection pins 6. This results in the isolating layer 14 being positioned exactly and reproducibly. The isolating layer 14, which is initially still somewhat flexible, rests closely on the winding element 11.

The partially fitted arrangement is then subjected to heat treatment, by which means the isolating layer 14 is cured, and the electrical conductors of the winding element 11 are fixed in.

The electrical conductors which are used for the winding system 9 can preferably be in the form of stove-enamel wires which have an additional surface coating, as well as the electrically conductive core and varnish insulation applied to it. The surface coating can likewise be cured by heat and is likewise slightly sticky in the uncured state. After curing, this surface coating leads to the electrical conductors of one of the winding elements 11 and 12 being joined together to form a mechanically robust assembly. This results in the shape of the winding element 11 or 12 also being permanently fixed outside the slots 7, that is to say in particular in the area of the end windings.

The isolating layer 14 and the stove-enamel wires of the winding element 11 which is covered by the relevant isolating layer 14 are preferably cured at the same time. By way of example, this can be done by placing a segment disk, which is matched to the stator geometry and in particular can be heated, as an auxiliary tool onto the isolating layer 14, with or without contact pressure. The isolating layer 14 and the stove-enamel wires are cured in this area by heating this segment disk. The isolating layer 14 which has then been cured is then matched to the surface geometry of the covered winding element 11. The isolating layer 14 makes very close contact and is dimensionally rigid, as a result of which the winding element retains its shape.

The winding of the further winding element 12 can then be started, whose electrical conductors do not make mechanical or electrical contact with the conductors of the winding element 11, because of the isolating layer 14 which is located between them. This is not only the case, but is particularly advantageous, when the two adjacent winding elements 11 and 12 are associated with different electrical phases of the winding system 9. The isolating layer 14 then also carries out the function of phase isolation.

The options for use of the isolating layer 14 are highly variable. As a stamped part, it can be matched very easily to other requirements. The isolating layers 14, which can be matched and used in a variable manner, also allow automated production of winding systems 9 for electrical machines 1 having a greater number of poles, by means of a direct winding technique. In particular, this also makes it possible to produce electrical machines 1 having at least two poles, and in particular four, six or eight poles.

The end windings manufactured in this way are highly compact. They require little space. There is no need for separate pressing of the end windings. There is likewise no need for additional fixing of the winding element shapes by means of end winding bindings. Completely adequate position fixing is achieved simply by the isolating layers 14, which can be cured by heat, and by the possibly additionally provided surface coatings, which can be cured by heat, on the electrical conductors.

1.-10. (canceled)

11. An electrical machine, comprising:
a base body having axial end faces;
end disks arranged on the end faces in one-to-one correspondence and having axially projecting deflection pins,
a winding system having electrical conductors received in slots of the base body, said electrical conductors of the winding system being passed around the deflection pins such that each of the end faces is formed with an end winding, said winding system having a plurality of winding elements, with at least sections of the winding elements arranged axially adjacent to one another in the area of the end windings; and
an electrically insulating isolating layer made of a matt-like material which is flexible at least in a basic state, said isolating layer being provided in an overlap zone between two winding elements which are arranged axially adjacent to one another in the area of the end windings.

12. The electrical machine of claim 11, wherein the isolating layer comprises a fiber fabric.

13. The electrical machine of claim 11, wherein the matt-like material of the isolating layer is impregnated with a resin.

14. The electrical machine of claim 13, wherein the resin of the matt-like material of the isolating layer is cured in the finally fitted state of the end windings.

15. The electrical machine of claim 11, wherein the matt-like material of the isolating layer is cured by heat.

16. The electrical machine of claim 11, wherein the electrical conductors of the winding system are provided with a surface coating which is cured by heat.

17. The electrical machine of claim 11, wherein, in a finally fitted state, at least some of the electrical conductors of a winding element are connected to one another in the area of the end windings.

18. The electrical machine of claim 11, wherein at least some sections of the isolating layer are in close contact with a surface contour of one of the two winding elements which are arranged axially adjacent to one another and between which the isolating layer is arranged.

19. The electrical machine of claim 11, wherein the isolating layer is a stamped-out element.

20. The electrical machine of claim 11, wherein the isolating layer has openings for passage of the deflection pins.
